(19) United States
(12) Patent Application Publication
(10) Pub. No.: US 2016/0185368 A1
(43) Pub. Date: Jun. 30, 2016

(54) METHOD OF REMOTELY RESETTING LOCOMOTIVE CONTROL SYSTEMS

(71) Applicant: Electro-Motive Diesel, Inc., LaGrange, IL (US)

(72) Inventors: Dennis MELAS, Chicago, IL (US); Isaac Suwa TRAYLOR, Brookfield, IL (US); Gregory Raymond KUPIEC, Lemont, IL (US); Paul P. JEZIOR, Streamwood, IL (US)

(73) Assignee: Electro-Motive Diesel, Inc., LaGrange, IL (US)

(21) Appl. No.: 14/585,029

(22) Filed: Dec. 29, 2014

(51) Int. Cl. B61L 27/00; B61L 3/00; B61K 9/00; G05B 15/02

(52) U.S. Cl. CPC B61L 27/0094; G05B 15/02; B61L 3/006; B61K 9/00

(57) ABSTRACT

A method of resetting a control system of a machine is disclosed. The method may include observing a condition of the machine from off-board the machine and determining a fault associated with the control system based on the condition. The control system may include a controller onboard the machine and at least one breaker in communication with the controller. The method may further include generating a command from off-board the machine directing the controller to attempt to automatically reset the control system. Automatically resetting the control system may include cycling the at least one breaker or rebooting the controller.

### TECHNICAL FIELD

The present disclosure relates generally to a method of controlling a locomotive and, more particularly, to a method of remotely resetting control systems of a locomotive.

### BACKGROUND

Large mobile machines, for example locomotives, often include one or more electronic control systems for controlling various functions of the machine. For example, locomotive control systems can include controllers that govern the power supplied to actuators, such as traction motors, and circuit breakers that protect the actuators from receiving too much current. When circuit breakers trip or when unexpected functionality is observed by a remote dispatcher, the dispatcher asks the locomotive operator to manually reset the breaker or to cycle the power to the controller of the system affected. In some instances, more than one circuit breaker or controller may require resetting or cycling. Each time this happens, the dispatcher has to wait for the operator to take action before the issue can be resolved, and the operator's attention is diverted from other tasks.

One attempt to improve circuit control in a railway vehicle is disclosed in U.S. Pat. No. 801,238 to Hill, that issued on Oct. 10, 1905 (“the '238 patent”). In particular, the '238 patent discloses a system that can be used to reset a circuit breaker on the vehicle that is distant from the operator. The system includes motors connected via a circuit breaker to a motor controller near the operator. Excessive current through the circuit breaker energizes a solenoid that moves a contact arm in the circuit breaker to an open position, thereby breaking the circuit. When it is desired to reset the circuit breaker in order to return power to the motors, a switch near the operator is pushed to energize an actuating coil within the circuit breaker that moves the contact arm to a closed position, and the contact arm is held in place by a holding coil to maintain the completed circuit.

Although perhaps somewhat successful in permitting the operator to reset a distant circuit breaker, the system of the '238 patent may be limited. In particular, there may be times when multiple circuit breakers need to be reset more than once in order to diagnose or resolve unexpected behavior. Such actions may be complicated and distracting to the operator who may be focused on other tasks. There may also be times when no breakers have been tripped but unexpected behavior has been observed by a remote dispatcher, and the dispatcher may wish to have power to one or more breakers or controllers cycled in order to remedy the unexpected behavior. Such requests may distract the operator and increase the amount of time needed to correct the unexpected behavior.

The present disclosure is directed at overcoming one or more of the shortcomings set forth above and/or other problems of the prior art.

### SUMMARY

In one aspect, the present disclosure is directed to a method of resetting a control system of a machine. The method may include observing a condition of the machine from off-board the machine and determining a fault associated with the control system based on the condition. The control system may include a controller onboard the machine and at least one breaker in communication with the controller. The method may further include generating a command from off-board the machine directing the controller to attempt to automatically reset the control system. Automatically resetting the control system may include cycling the at least one breaker or rebooting the controller.

In another aspect, the present disclosure is directed to method of resetting a control system of a machine. The method may include observing a condition of the machine from off-board the machine, determining a difference between the condition and an expected condition, and determining a fault associated with the control system based on the difference. The control system may include a controller onboard the machine and at least one breaker in communication with the controller. The method may further include generating a command from off-board the machine based on the fault and wirelessly directing the controller to attempt to automatically reset the control system. Automatically resetting the control system may include cycling the at least one breaker or rebooting the controller. The method may further include determining a number of previous automatic reset attempts, preventing subsequent automatic reset attempts based on the number of previous automatic reset attempts, generating an override command from off-board the machine based on the number of previous automatic reset attempts, and wirelessly directing the override command to the at least one breaker. The override command may include cycling the at least one breaker.

In yet another aspect, the present disclosure is directed to a control system for a machine. The control system may include a device associated with an operation of the machine, at least one breaker configured to provide power to the device, and an onboard controller in communication with the device and the at least one breaker. The onboard controller may be configured to automatically cycle the at least one breaker and reboot the onboard controller. The control system may further include an off-board controller in communication with the onboard controller and with the breaker. The off-board controller may be configured to observe a condition of the machine, determine a fault based on the condition, and wirelessly command the onboard controller to automatically attempt to reset the control system based on the fault. Resetting the control system may include cycling the at least one breaker or rebooting the onboard controller.

### BRIEF DESCRIPTION OF THE DRAWING

FIG. 1 is a diagrammatic illustration of a machine equipped with an exemplary disclosed control system; and

FIG. 2 is a flow chart showing an exemplary disclosed method of resetting the control system of FIG. 1.

### DETAILED DESCRIPTION

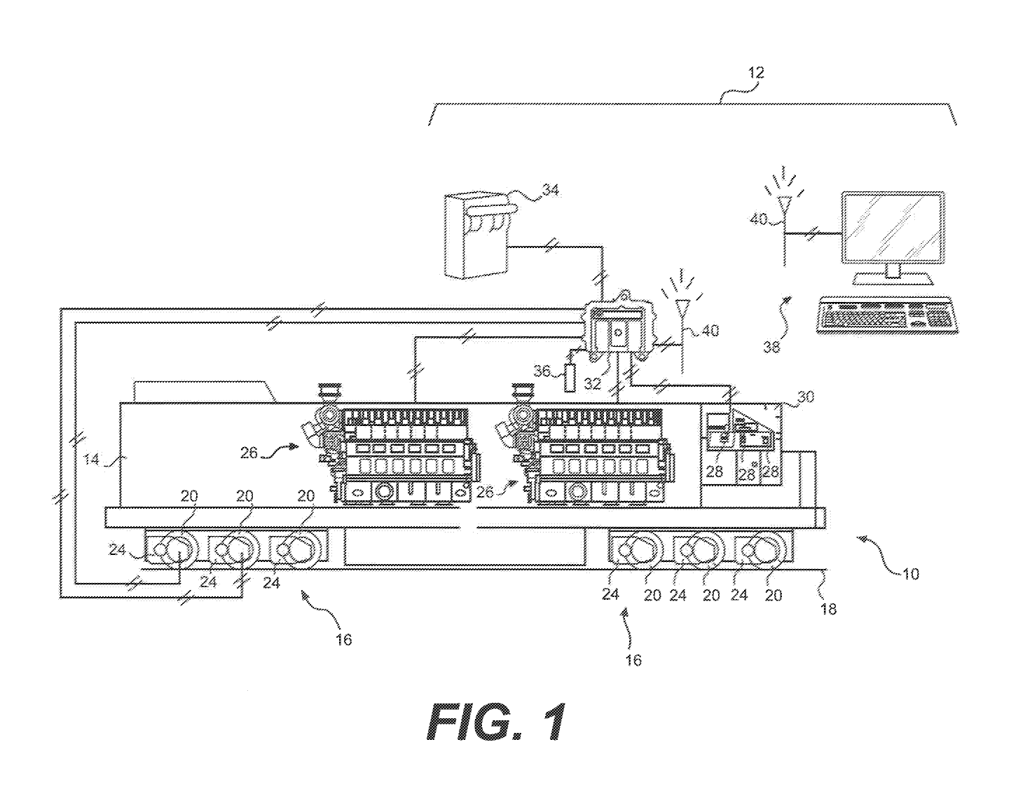

FIG. 1 illustrates a mobile machine 10 equipped with an exemplary control system 12. In the disclosed example, machine 10 is a locomotive. However, it is contemplated that machine 10 may embody another type of machine, if desired. For example, machine 10 may embody an on- or off-highway haul truck, a construction machine, a vocational machine, or another type of machine. Alternatively, machine 10 could be a stationary machine, such as a genset, a pump, or a drill that requires continuous attention from an operator. Other types of machines may also be possible.

As a locomotive, machine 10 may include a car body 14 supported at opposing ends by a plurality of trucks 16 (only two trucks 16 shown). Each truck 16 may be configured to engage a track 18 via a plurality of wheels 20, and to support a frame 22 of car body 14. One or more traction motors 24 may be associated with one or all wheels 20 of a particular truck 16, and any number of engines 26 may be mounted to frame 22 within car body 14 and drivingly connected to produce power that drives traction motors 24 to propel wheels 20.

Control system 12 may control operations of machine 10 such as engine operation (e.g., starting, stopping, fueling, etc.), traction motor operation, and/or operation of other locomotive functions. Control system 12 may be one of several control systems associated with machine 10 and may be dedicated to controlling one or more particular operations of machine 10. Control system 12 may include devices associated with one or more operations of machine 10 (e.g., engines 26, traction motors 24, etc.), input devices 28 that may be provided by way of a cabin 30 supported by frame 22, and an onboard controller (OC) 32.

Cabin 30 may house a plurality of input devices 28 associated with control system 12 and in communication with OC 32. Input devices 28 may be used by the operator to control machine 10 and embody any type of device known in the art. For example, input devices 28 may include, among other things, any number of breakers 34, switches, levers, pedals, wheels, knobs, push-pull devices, touch screen displays, etc.

Breakers 34 may each be associated with a particular component of machine 10, and configured to trip when performance parameters associated with the component deviate from expected ranges. For example, a breaker 34 may be configured to provide power to one or more power consumers such as individual traction motors 24, an HVAC component, lighting controllers or control systems, etc. In this example, when a power draw greater than an expected draw occurs, breakers 34 may trip to interrupt the corresponding circuit. After a particular breaker 34 trips, the associated component may be disconnected from circuitry of machine 10 and remain nonfunctional until the corresponding breaker 34 is reset.

Breakers 34 may include actuators that can be selectively energized to autonomously or remotely toggle the state of the associated breakers 34 in response to a corresponding command. For example, breakers 34 may include solenoids, motors, or other types of actuators configured to reset, trip, or cycle switches, contacts, etc., within breakers 34 upon command from the operator, OC 32, or a remote device. Breakers 34 may also include a handle, lever, switch, etc., and be manually toggled by the operator, if desired.

OC 32 may be in communication with one or more devices of machine 10 such as traction motors 24, engines 26, and input devices 28. OC 32 may also be in communication with one or more sensors 36 and an off-board worksite controller (OWC) 38 via a communications device 40. OC 32 may embody a single or multiple microprocessors, field programmable gate arrays (FPGAs), digital signal processors (DSPs), etc., that include a means for controlling operations of machine 10 in response to operator requests, built-in constraints, sensed operational parameters, and/or communicated instructions from OWC 38. Numerous commercially available microprocessors can be configured to perform the functions of these components. Various known circuits may be associated with these components, including power supply circuitry, signal-conditioning circuitry, actuator driver circuitry (i.e., circuitry powering solenoids, motors, or piezo actuators), and communication circuitry.

Machine 10 may be outfitted with any number and type of sensors 36 known in the art for generating signals indicative of associated performance parameters. Sensors 36 may include, for example, a brake temperature sensor; an exhaust sensor; a fuel level, pressure, and/or temperature sensor; a boost temperature or pressure sensor; a knock sensor; a reductant level and/or temperature sensor; an oil level, pressure, and/or temperature sensor; a speed sensor; or any other sensor known in the art. The signals generated by sensor(s) 36 may be directed to OC 32 for further processing.

OWC 38 may include any means for monitoring, recording, storing, indexing, processing, and/or communicating various operational aspects of machine 10. These means may include components such as, for example, a memory, one or more data storage devices, a central processing unit, or any other components that may be used to run an application. Furthermore, although aspects of the present disclosure may be described generally as being stored in memory, one skilled in the art will appreciate that these aspects can be stored on or read from different types of computer program products or computer-readable media such as computer chips and secondary storage devices, including hard disks, floppy disks, optical media, CD-ROM, or other forms of RAM or ROM.

OWC 38 may be configured to execute instructions manually entered by a remote user or stored on computer readable medium to analyze information and perform methods of remote control of machine 10. That is, as will be described in more detail in the following section, onboard control (manual and/or autonomous control) of some operations of machine 10 (e.g., operations of traction motors 24, engine(s) 26, breakers 34, etc.) may be selectively overridden by OWC 38. For example, OWC 38 may be configured to selectively override OC 32 in order to cut, restore, cycle power to, or otherwise reset control system 12. Resetting control system 12 may refer to cutting, restoring, or cycling power to one or more components (e.g. traction motors 24, input devices 28, OC 32, breakers 34, etc.) of control system 12.

Remote control of machine 10 between OC 32 and OWC 38 may be facilitated via a communications device 40. Communications device 40 may include hardware and/or software that enables sending and receiving of data messages between OC 32 and OWC 38. The data messages may be sent and received via a direct data link and/or a wireless communication link, as desired. The direct data link may include an Ethernet connection, a connected area network (CAN), or another data link known in the art. The wireless communications may include satellite, cellular, infrared, and any other type of wireless communications that enable communications device 40 to exchange information between OWC 38 and the components of OC 32.

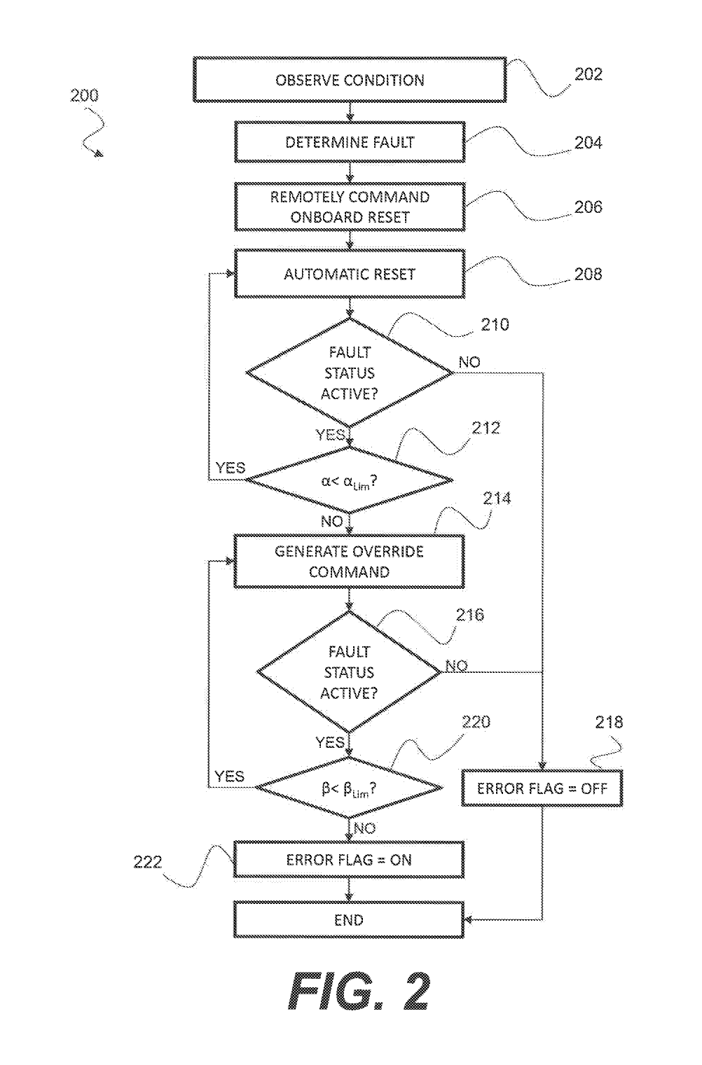

Based on information from input devices 28 and sensor(s) 36, and based on instructions from OWC 38, OC 32 may be configured to help regulate movements and/or operations of its associated machine 10 (e.g., direct operations of associated traction motors 24, engines 26, breakers 34, etc.). OC 32 may be configured to autonomously control these movements and operations. OC 32 may also be configured to send operational information associated with components of machine 10 off-board to OWC 38 via communications device 40, if desired. This information may include, for example, parameters associated with signals generated by sensor(s) 36, positions of breakers 34, a state of engine(s) 26, conditions of traction motors 24 (e.g. power output, power output requested, etc.), and other information known in the art. The information may then be received and displayed at a remote facility housing OWC 38 for use by a remote user in determining operational commands for machine 10. Operational commands for machine 10 may be sent from OWC 38 to OC 32 automatically by OWC 38 or manually by a remote user based on the received information. Operational commands may include, among other things, commands for resetting control system 12 or portions of control system 12. A method of resetting subsystems will be described in the following section with reference to FIG. 2.

### INDUSTRIAL APPLICABILITY

The method of the present disclosure may be applicable to any machine where remotely resetting control systems of the machine may be desirable. These functions may normally be performed manually from onboard the machine, and remote access to these functions may provide a way to reduce the time spent in achieving fault resolution and/or reduce distractions to the operator. A method 200 of operating control system 12 will now be described in detail with reference to FIG. 2.

During normal operation, an operator may be located onboard machine 10 and within cabin 30. Periodically, breakers 34 may trip or a dispatcher may contact the operator and request the operator to cycle power to one or more breakers 34 or another component of control system 12 (e.g. individual traction motors 24, OC 32, etc.). The operator may be able to control, for example, when and what breakers 34 should be reset, tripped, or cycled or when OC 32 should be rebooted. Rebooting OC 32 may include cycling power to OC 32, for example, by cycling a breaker 34 that connects OC 32 to a power source or by pressing a power button connected to OC 32. OC 32 may include an inbuilt “restart” function, and rebooting OC 32 may include initiating the inbuilt “restart” function of OC 32. However, there may be times when the operator is not available to perform these functions and/or when the operator is not sufficiently trained or alert to perform these functions.

For example, during normal operation of machine 10 when the operator is focused on a task such as controlling speed, braking, handling, etc., of machine 10, a remote user may also be monitoring various conditions and/or operating parameters associated with machine 10. The remote user may be a dispatcher or other personnel having access to OWC 38 or any other device (e.g. GUI, cellular phone, tablet, PC, etc.) capable of receiving information from OC 32 via communications device 40. OWC 38 may also function as a remote user and may include instructions stored on computer readable medium to analyze information and perform methods of remote control. The remote user may observe a condition (e.g. signals from sensor(s) 36, positions of breakers 34, a state of engine(s) 26, power output of traction motors 24, power requested of traction motors 24, etc.) from off-board machine 10 (Step 202) and determine a fault based on the condition (Step 204).

The fault may be determined by any suitable method known in the art and may include, for example, determining whether the difference between the observed condition and an expected or requested condition is within a tolerable range. For example, the power output of individual traction motors 24 may be observed by the remote user and compared to an expected power output (e.g. a desired power output, a maximum or minimum power output, a requested power output, the power output of another traction motor 24, etc.). A fault may be determined when the difference between the power output and the expected power output of traction motors 24 is greater than or less than a permissible value. The fault may alternatively be determined by monitoring feedback signals from devices of machine 10 (e.g. breakers 34, traction motors 24, sensor(s) 34, OC 32, etc.) indicative of a condition of the respective device. For example, feedback signals (or absence thereof) may indicate when breakers 34 have tripped, when OC is malfunctioning, or when devices such as traction motors 24 are malfunctioning.

The remote user may decide to resolve the fault by resetting control system 12, which may include cycling power to one or more devices of control system 12. The remote user may then generate a command from off-board the machine commanding OC 32 to attempt to automatically reset control system 12 (Step 206). The remote user may wirelessly direct the command to OC 32 via wireless communications device 40. OC 32 may then attempt to automatically reset control system 12 (Step 208) based on, for example, the type of fault, the particular device associated with the fault, a frequency of the fault, etc. Automatically resetting control system 12 may include, for example, cycling one or more breakers 34, rebooting OC 32, or allowing OC 32 to reboot itself. Breakers 34 may be cycled by energizing an actuator such as a solenoid within each breaker 34. Energizing the actuator may toggle breakers 34 between an off-position and an on-position, thereby cutting and restoring power to the associated device. Rebooting OC may include cycling a breaker 34 that connects OC 32 to a power source or initiating an inbuilt “restart” function of OC 32 to allow OC 32 to reboot.

Automatically resetting control system 12 may further include determining whether the fault status is active or inactive after the previous automatic restart attempt (Step 210). An inactive fault status at step 210 may indicate that the previous automatic reset attempt was successful and that the fault has been resolved (Step 210; NO). The remote user may then progress to Step 218 and set an ERROR FLAG to an “OFF” position before ending method 200. An active fault status at step 210 may indicate that the previous automatic reset attempt was unsuccessful, and OC 32 may attempt to automatically reset control system 12 again (Step 210; YES). Before returning to step 208, OC 32 may first determine a number a of previous automatic reset attempts that have occurred (Step 212). When a is less than a first threshold α_{Lim}, OC 32 may repeat steps 208-210 and attempt to automatically reset control system 12 again (Step 212; YES). α_{Lim} may be any suitable number (e.g. one, two, or more) of permissible automatic resets that may be attempted before the risk of damaging control system 12 increases. When a is equal to or greater than α_{Lim}, OC 32 may instead prevent subsequent attempts to automatically reset control system 12 to avoid damaging control system 12 (Step 212; NO).

After α_{Lim} has been reached, there may be times when the remote user may sill wish to continue reseting particular breakers 34 or OC 32 in order to continue troubleshooting the fault. For example, when the fault status remains active after α_{Lim} has been reached, the remote user may wish to cycle other breakers 34 than those cycled by OC 32 during previous automatic reset attempts. The remote user may then generate an override command from off-board machine 10 (Step 214) and attempt to directly reset control system 12. The override command may include cycling one or more breakers 34 or rebooting OC 32, and the override command may be wirelessly directed to breakers 34 or OC 32, respectively, via communications device 40. The override command may be automatically generated by OWC 38 according to instructions stored on computer readable medium within OWC 38. Alternatively, the override command may be manually generated by off-board personnel, such as a dispatcher, by entering instructions into OWC 38.

The remote user may then determine the status of the fault after generating the previous override command (Step 216). When the remote user determines an inactive fault (Step 216; NO), the remote user may proceed to step 218 and set the ERROR FLAG to the “OFF” position before ending method 200. When the remote user determines an active fault status (Step 216; YES), the remote user may generate the override command again. For example, there may be times when the remote user may wish to cycle the same or different breakers 34 than those cycled according to the previous override command in order to continue trouble shooting the fault. There may also be times when the remote user wishes to continue cycling a breaker in order to maintain a particular machine function. Thus multiple override commands may be permitted by OWC 38. However, before returning to step 214, the remote user may first determine a number 13 of previously generated override commands (Step 220). When β is less than a second threshold β_{Lim} (Step 220; YES), the remote user may repeat steps 214-216 and attempt to reset control system 12. β_{Lim} may be any suitable number (e.g. one, two, or more) of permissible override commands that may be generated before the risk of damaging control system 12 increases. When β is equal to or greater than β_{Lim} (Step 220; NO), the remote user may prevent subsequent override commands to avoid damaging control system 12, and the remote user may then set the ERROR FLAG to an “ON” position (Step 222) before ending method 200. The state of the ERROR FLAG (e.g. “ON” or “OFF”) may be utilized by OWC 38 for further processing.

Because method 200 may allow for control system 12 to be remotely reset by an off-board user, operation of machine 10 may be simplified. In particular, the operator onboard machine 10 may not need to be distracted from other tasks to reset control system 12, allowing for more focused control of machine 10. In addition, because the disclosed method may not require involvement of the operator, faults may be resolved in less time.

It will be apparent to those skilled in the art that various modifications and variations can be made to the method of the present disclosure without departing from the scope of the disclosure. Other embodiments will be apparent to those skilled in the art from consideration of the specification and practice of the method disclosed herein. It is intended that the specification and examples be considered as exemplary only, with a true scope of the disclosure being indicated by the following claims and their equivalents.

What is claimed is:

1. A method of resetting a control system of a machine, comprising:
observing a condition of the machine from off-board the machine;
determining a fault associated with the control system based on the condition, the control system including:
a controller onboard the machine; and
at least one breaker in communication with the controller; and
generating a command from off-board the machine directing the controller to attempt to automatically reset the control system, wherein automatically resetting the control system includes cycling the at least one breaker or rebooting the controller.

2. The method of claim 1, wherein:
the machine further includes one or more traction motors; and
observing the condition of the machine includes observing a power output of the one or more traction motors.

3. The method of claim 2, wherein determining the fault includes comparing the power output of the one or more traction motors to a requested output.

4. The method of claim 1, wherein observing the condition of the machine includes observing a feedback signal from the at least one breaker.

5. The method of claim 1, wherein:
the at least one breaker includes an actuator configured to toggle the at least one breaker between an off-position and an on-position when energized; and
cycling the at least one breaker includes energizing the actuator.

6. The method of claim 1, wherein:
the controller includes an inbuilt restart function; and
rebooting the controller includes initiating the inbuilt restart function.

7. The method of claim 1, further including directing the command to the controller wirelessly.

8. The method of claim 1, wherein:
automatically resetting the control system further includes determining an inactive status of the fault after a previous automatic reset attempt; and
setting an error flag to an off-position based on the inactive status of the fault.

9. The method of claim 1, wherein:
automatically resetting the control system further includes determining an active status of the fault after a previous automatic reset attempt; and
attempting to automatically reset the control system again based on the active status of the fault.

10. The method of claim 9, wherein automatically resetting the control system further includes:
determining a number of previous automatic reset attempts; and
attempting to automatically reset the control system again when the number of previous automatic reset attempts is below a first threshold.

11. The method of claim 10, wherein automatically resetting the control system further includes preventing subsequent attempts to automatically reset the control system when the number of previous automatic reset attempts is equal to or greater than the first threshold.

12. The method of claim 11, further including generating an override command from off-board the machine, wherein the override command includes cycling the at least one breaker.

13. The method of claim 12, further including directing the override command to the at least one breaker wirelessly.

14. The method of claim 12, wherein the override command is automatically generated by an off-board computer.

15. The method of claim 12, wherein the override command is manually generated by off-board personnel.

16. A method of resetting a control system of a machine, comprising:
observing a condition of the machine from off-board the machine;
determining a difference between the condition and an expected condition;
determining a fault associated with the control system based on the difference, the control system including:
a controller onboard the machine; and
at least one breaker in communication with the controller; and
generating a command from off-board the machine based on the fault;
wirelessly directing the controller to attempt to automatically reset the control system, wherein automatically resetting the control system includes cycling the at least one breaker or rebooting the controller;
determining a number of previous automatic reset attempts;
preventing subsequent automatic reset attempts based on the number of previous automatic reset attempts; and
generating an override command from off-board the machine based on the number of previous automatic reset attempts; and
wirelessly directing the override command to the at least one breaker, the override command including cycling the at least one breaker.

17. A control system for a machine, comprising:
a device associated with an operation of the machine;
at least one breaker configured to provide power to the device;
an onboard controller in communication with the device and the at least one breaker, the onboard controller being configured to automatically cycle the at least one breaker and reboot the onboard controller;
an off-board controller in communication with the onboard controller and with the at least one breaker and configured to:
observe a condition of the machine;
determine a fault based on the condition; and
wirelessly command the onboard controller to automatically attempt to reset the control system based on the fault, wherein resetting the control system includes cycling the at least one breaker or rebooting the onboard controller.

18. The control system of claim 17, wherein the onboard controller is further configured to:
determine a number of previous automatic reset attempts; and
prevent subsequent automatic reset attempts based on the number automatic reset attempts.

19. The control system of claim 18, wherein the off-board controller is further configured to wirelessly direct an override command to the at least one breaker, the override command including cycling the at least one breaker.

20. The control system of claim 17, wherein the at least one breaker includes an actuator configured to toggle the at least one breaker between an off-position and an on-position when energized.
